(19) United States
(12) Patent Application Publication
(10) Pub. No.: US 2017/0260352 A1
(43) Pub. Date: Sep. 14, 2017

(54) PROCESS OF FABRICATION OF SUBMICRON ALIGNED HYDROPHOBIC AND OLEOPHILIC FIBRE FROM POLYSTYRENE WASTE WITH CONTROLLABLE GEOMETRY USING-CITRUS PEEL EXTRACT AS SOLVENT

(71) Applicant: Indian Institute of Technology Hyderabad, Medak District, Telangana (IN)

(72) Inventors: Shekhar Chandra Sharma, Telangana (IN); Shital Yadav, Telangana (IN)

(73) Assignee: Indian Institute of Technology Hyderabad, Medak District, Telangana (IN)

(21) Appl. No.: 15/529,837

(22) PCT Filed: Nov. 26, 2015
(86) PCT No.: PCT/IB2015/002220

§ 371 Date: May 25, 2017

(30) Foreign Application Priority Data
Nov. 26, 2014 (IN) 5928/CHE/2014

(51) Int. Cl. C08J 11/08; A23L 19/00; D01D 1/02; D01F 6/22; D01D 5/00

(52) U.S. Cl. CPC C08J 11/08; D01F 6/22; D01D 5/00; D01D 1/02; A23L 19/07

(57) ABSTRACT

The present invention discloses a simple mechanical method of fabrication of sub-micron aligned free standing hydrophobic and oleophilic fibers of polystyrene waste using extracts obtained from the peel of any citrus fruit such as orange, lemon, sweet lime, kinnow etc. as solvent. Fibers are aligned and useful in making different geometries. Process of making film using this process is facile and fast and film obtained is free standing film. Process set-up have minimum requirement and is inexpensive. This method is simple and flexible with respect to set-up and process. This process has the potential of being industrialized. Therefore, this method can be beneficial in dealing with both the orange peel and polystyrene waste.

### FIELD OF THE INVENTION

The present invention relates to a process of fabrication of sub-micron aligned hydrophobic and oleophilic polystyrene fibers with controllable geometry manually and more particularly relates to a process of fabrication done using extracts obtained from the peel of a citrus fruits solvent.

### BACKGROUND OF THE INVENTION

Oranges find its main application in juice industries. The thick bitter peels are removed in the process of making juice. These discarded peels are difficult to dispose and are categorized as solid agricultural waste.

Orange peels can be processed into animal feed by desiccation, using pressure and heat. Orange oil can be obtained by pressing the peel and is the by-product of juice industry which is used for flavoring food and for imparting fragrance in perfume industry. The peel of orange is rich in many components such as limonene that is used in cosmetics, perfume industry, flavoring of food, insecticides, as a solvent and as a household cleaner; pectin that is used in cosmetics, pharmaceuticals and in food like jellies; α-Pinene which is anti-inflammatory in nature; and other components such as myrcene, linalool etc. These peels are used as adsorbents in industries for removal of dyes, water purification etc. Moreover, orange peel is edible and has higher Vitamin-C content.

Polystyrene (PS) is one of the most widely used thermoplastic polymer. It is used as solid PS in applications such as electronics, construction, house and medical ware, disposal food services etc. Whereas, for protective packaging, in electrical, pharmaceutical and retail industries etc., it is used in form of foam, because of its light weight, shock resistance, cushioning properties, and flexibility in design possibilities. But PS comes with the disadvantage of being non-biodegradable and therefore, raises concern over its impact on health and environment. PS is major component of plastic debris in ocean, where it becomes hazardous to marine life. Also, Styrofoam blows in wind and floats on water, making it difficult to collect and control the waste. PS packaging products are usually discarded in dumps, landfills or simple litter after their useful application. As the polystyrene waste material has become a serious problem, recycling is getting attention to save environment and resource recovery.

There are different forms in which a material or polymer can be used such as films, particles, micro- or nano-fibers, gels etc. Among these, micro- or nano-fibers have an advantage of having high surface to volume ratio and high porosity. The pores formed between the fibers in the matrix and pores on the surface of the fibers, together contributes towards porosity of the matrix.

Depending upon the end-product specifications or applications, different techniques can be used to make fibers. Some of the techniques are listed as follows: (i) drawing wherein fibers are drawn while polymer is still solidifying; (ii) electro spinning wherein it uses electrically charged jet of polymer solution to make fibers; (iii) wet spinning wherein polymer solution is extruded in precipitating liquid to get fibers; (iv) dry spinning wherein solidification is achieved by evaporating the solvent in a stream of air or inert gas; (v) melt spinning uses polymer melt to pass through spinneret; (vi) template synthesis implies the use of template or mold to a get desired shape of a product; (vii) phase separation is based on the separation of phases due to physical incompatibility; and (viii) self-assembly refers to building up of nanoscale fibers using smaller molecules as building blocks.

Micro- or nano-fibers, as mentioned above, can be produced by many techniques and are advantageous over other forms in which polymers are used. As a result, fibers have many applications. Some of the application areas for nanofibers are bioengineering which includes tissue engineering, wound dressing, drug delivery; defense and security where fibers are used in making protective clothing against chemical and biological warfare agents. sensors for detecting chemicals and composite reinforcement; energy and electronics wherein it is used in Li-ion battery, photovoltaic cells, membrane fuel cells and capacitors; environment for air and water purification; and in textile industries.

Limitations of Current Uses of Orange Peel:

There are different ways to eliminate waste orange peel but they are dangerous to the environment. If orange peels are burned, then it produces carbon dioxide and other greenhouse gases and if dumped in landfills, then oil present in peel will percolate into soil and effect the plant life. Other way to eliminate the waste orange peel is heat treatment wherein the peel are treated under specific hear to dry the orange peel but application of heat destroys/evaporates all the valuable components present in it. Yet another way is by distillation wherein it is used to extract components present in the orange peel. But this process needs precise control over the parameters and operation and needs electricity which adds to its operation cost. Hence the most favorable and inexpensive way to eliminate the waste orange peel and an alternative to the above mentioned processes is to find the application of it.

Limitations of Nano-Fibers Processes:

Methods, discussed above for preparing nano-fibres, have their own limitations as follows. Drawing is a discontinuous process; phase separation is specific to polymers and self-assembly is a complex process. Wet spinning requires more than one bath for complete removal of solvent; post-spinning method is lengthy and it is difficult to control fiber cross section due to inward and outward mass transfer. In melt spinning, only limited polymers can be used and structural development rate is poor due to high solidification rate which reduces its strength. Moreover, temperature control is required to get optimum properties of fibers in melt spinning. Dry spinning also require post-spinning treatment for complete removal of solvent. In electro-spinning, it is difficult to get aligned fibers.

The common limitation found in all the methods mentioned above is that the difficulty in preparing solution for the particular technique. It is specific to the process being used and requires determination of accurate properties of solvent for the polymer and solution like concentration, surface tension, viscosity, effect of solvent on morphology of fibers and toxicity of the chemicals added.

Limitations of Recycling of Polystyrene Waste:

The three main alternatives for PS recycling are, mechanical, chemical and thermal recycling. Mechanical recycling involves relatively simple technologies for converting scrap PS into new product, by compressing and melting. But it can be quite labour- or energy-intensive, depending on whether the process is manual or automated. Chemical recycling can have high capital cost such as in catalytic degradation of PS. whereas, toxic emission in thermal recycling refrains its use. All recycling methods involve energy input as the preliminary step either to crush PS objects into granules or thermally degrade them.

It can be concluded that polystyrene fibers can be obtained from polystyrene waste objects using orange peel extract and peel extract of other citrus fruits like lemon, mosambi (sweet lime), kinnow etc. This method can be beneficial in dealing with the orange peel waste. U.S.20120135448 entitled “Methods and devices for the fabrication of 3D polymeric fibers” discloses a device for the fabrication of a micron, sub-micron or nanometer dimension polymeric fiber comprising a rotating reservoir suitable for accepting a polymer and comprising an orifice for ejecting said polymer during rotation of said reservoir. However, it does not produce multiple fibers at a time and different morphologies of fibers cannot be obtained. Moreover, a collector is needed to withstand the obtained fibers.

U.S. Pat. No. 8,481,099 entitled “Process for conversion of citrus peels into fiber, juice, naringin and oil” describes a process for converting citrus peel waste into citrus oil, citrus fiber and naringin comprising: pressing citrus peels having residual vesicles attached thereto with sufficient pressure to release citrus juice from within vesicles; removing the citrus juice from the pressed citrus peels; pulverizing the citrus peels in water to create a slurry of particles; separating the slurry of particles into citrus peel puree and a first supernatant, wherein the first supernatant comprises solubilized naringin and citrus oil; and collecting debittered citrus pulp from the citrus peel puree using a washing process, wherein the washing process comprises creating a suspension of the citrus peel puree in water, heating the suspension to a temperature ranging from about 150° F. to about 230° F. and then separating the suspension into debittered citrus pulp and a second supernatant. But this process is expensive wherein the dietary fibers are obtained and this process makes fibres by the peel itself and not from the extract obtained from the peel.

WO2006033697 entitled “High flux nano fibrous membranes” discloses a process of recovering citrus fibre from citrus vesicles to obtain a food additive, the process comprising: (i) washing citrus vesicles with water and recovering water washed vesicles therefrom; (ii) contacting the water washed vesicles with an organic solvent to obtain organic solvent washed vesicles; and (iii) desolventizing the organic solvent washed vesicles and recovering dried citrus fiber therefrom.

U.S. Pat. No. 7,169,250 entitled “Nanofibrous articles” describes a method for manufacturing an ordered nanofibrous article, comprising: preparing a surface of a substrate to provide an adhesion mechanism for a plurality of nanofibres; dispersing a plurality of said nanofibres to be adhered to said surface; providing an electric field to selectively control an ordering of said nanofibres while said nanofibers are being dispersed onto said surface having said adhesion mechanism, wherein the electric field at least controls the ordering of said nanofibres prior to said nanofibres touching said surface.

WO2012016190 entitled “Process for obtaining citrus fiber from citrus pulp” discloses a process for preparing citrus fibers from citrus pulp, the process comprising: treating citrus pulp to obtain homogenized citrus pulp; washing the homogenized citrus pulp with an organic solvent to obtain organic solvent washed citrus pulp; desolventizing and drying the organic solvent washed citrus pulp; and recovering citrus fiber therefrom.

But none of the above mentioned prior arts discloses an inexpensive and a simple process of obtaining nano fibres from waste polystyrene objects using the extract of the peel of a citrus fruit. In this work we present a novel and innovative way to recycle objects made up of PS directly into sub-micron, aligned PS fibers using citrus fruit's peel extract. The fibers produced were then characterised in terms of surface morphology, crystal size, surface area, thermal stability and wettability behaviour. The fibers were found to be hydrophobic and oleophilic. Based on this property, these fibers were then tested as a sorbent material for oil. Buoyancy test was also done to check if fibers floats on water after absorption of oil and it was found that these fibers have great potential to be used as sorbent material for oil.

Fibers of ploystyrene obtained from the process disclosed wherein the solvent used is 100% natural since only peel extracts are used without any chemical addition for extracting the fibers. Fibers are aligned and useful in making different geometries. Process of making film using this process is fast and film obtained is free standing film. Further, by developing and implementing the process, the oil phase present in a citrus fruit, for example, orange, is taken from the peel as fibers. Hence, the fiber-extracted-peels can be safely dumped into landfills without affecting the soil and plant life.

The process set-up have minimum requirement and is inexpensive. This method is simple and flexible with respect to set-up and process. This process has the potential of being industrialized.

### SUMMARY OF THE INVENTION

A method of mechanical extraction of sub-micron aligned hydrophobic and oleophilic fibers by recycling polystyrene waste objects using citrus peel extract as solvent comprising the steps of: pressing the citrus peel and extracting the sample in a flat surface; pressing the sample in the flat surface with a long flat medium made of polystyrene waste objects; making a circular movement on the flat surface by the medium; pulling the medium horizontally away from the flat surface; and repeating the above mentioned steps till the sample gets dried.

The objective of the present invention is to produce submicron, aligned hydrophobic and oleophilic fibers from polystyrene waste with controllable geometry from extract obtained from the peel of any citrus fruit such as orange, lemon, kinnow, sweet lime etc. The present invention discloses a process which is simple, flexible and versatile with minimum requirements to make aligned polystyrene fibers.

### BRIEF DESCRIPTION OF THE DRAWINGS

The above-mentioned process along with others advantages of this present disclosure, and the manner of attaining them, will become more apparent and the present disclosure will be better understood by reference to the following description of embodiments of the present disclosure taken in conjunction with the accompanying drawings, wherein:

FIG. 1 illustrates the process of extraction of polystyrene fibers using citrus fruit's peel to obtain the extract;

FIG. 2 illustrates steps involved in making submicron polystyrene fibers from polystyrene waste objects using citrus fruit's peel extract;

FIG. 3 shows Scanning Electron Microscope (SEM) images depicting submicron, aligned polystyrene fibers obtained from orange peel extract in (a) and (b); from lemon peel extract in (c) and (d);

FIG. 4 shows the photos captured by a high definition digital camera and goniometer camera wherein: figure A (a) shows the image of water and oil droplet, A(b) shows the water droplet image on recycled polystyrene fiber mats derived from orange peel extract and figure B shows the water droplet image on lemon peel extract derived recycled polystyrene fibers respectively;

FIG. 5 shows the pictures of yarn and coil drawn from the polystyrene fibers obtained using citrus peel extract; The polystyrene fiber mat was cut into ribbons and was twisted from one end as represented in FIG. 5a-c. After certain twists into ribbon, yarn was obtained (FIG. 5d). If the yarn was over twisted, it starts converting into coil (FIG. 5e). SEM images of recycled polystyrene based yarn and coil (FIGS. 5f and 5g).

FIG. 6 illustrates the knot test conducted on the obtained fibers of polystyrene by the present invention; Knotted structures (a) square, (b) overhand and (c) weaver's knot; (d) coils after opening knot and (e) weaving different diameter coils.

FIG. 7 shows the experiment conducted with an eraser and scale instead of hand in terms of scaling up the process; and

FIG. 8 shows the scaled up experimental set up in order to obtain non-fibers from polystyrene object using citrus peel extract as solvent.

### DETAILED DESCRIPTION OF THE INVENTION

Reference will now be made in detail to the exemplary embodiment(s) of the invention. Before describing the detailed embodiments that are in accordance with the present disclosure, it should be observed that the embodiments reside primarily in combinations of process/method steps and the product.

In this document, the terms “comprises,” “comprising,” or any other variation thereof, are intended to cover a non-exclusive inclusion, such that a process, product, method, article, device or apparatus that comprises a list of elements does not include only those elements but may include other elements not expressly listed or inherent to such process, product, method, article, device, or apparatus. An element proceeded by “comprise . . . a” does not, without more constraints, preclude the existence of additional identical elements in the process, product, method, article, device or apparatus that comprises the element.

Any embodiment described herein is not necessarily to be construed as preferred or advantageous over other embodiments. All of the embodiments described in this detailed description are illustrative, and provided to enable persons skilled in the art to make or use the disclosure and not to limit the scope of the disclosure, which is defined by the claims.

It will be apparent to those skilled in the art that various modifications and variations can be made to the present invention without departing from the spirit and scope of the invention. Thus it is intended that the present invention covers the modifications and variations of this invention provided they come within the scope of the appended claims and their equivalents.

In the following description, for the purpose of explanation, numerous specific details are set forth in order to provide a thorough understanding of the present process of fabrication of submicron aligned hydrophobic and oleophilic fibers of polystyrene from citrus peel extract. It will be apparent, however, to one skilled in the art that the present invention can be practiced without these specific details.

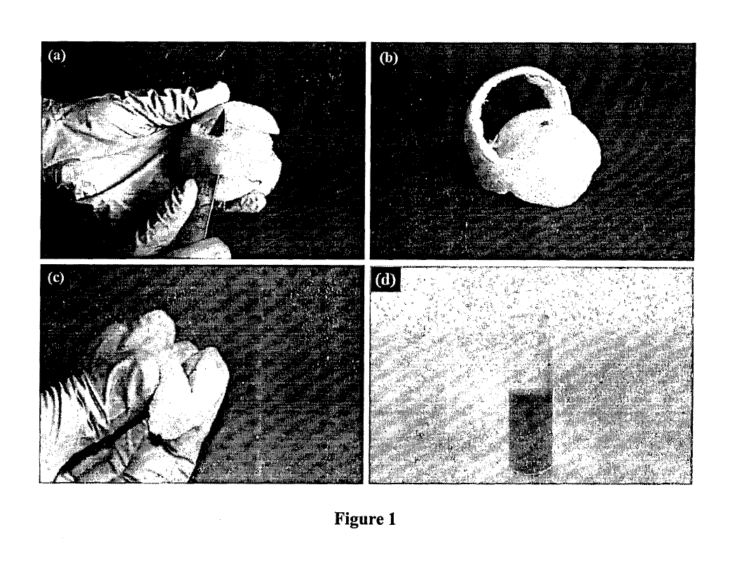

FIG. 1 shows the process of extraction of the sample from the citrus fruit's peel. The embodiments described with reference to the figures are with reference to orange peel extract but it is not limited to this fruit alone. The process of extraction of the sample includes removing the peel of the orange 1(b); squeezing the peel hardly to extract the sample from the same 1(c); and collecting sample in a container 1(d).

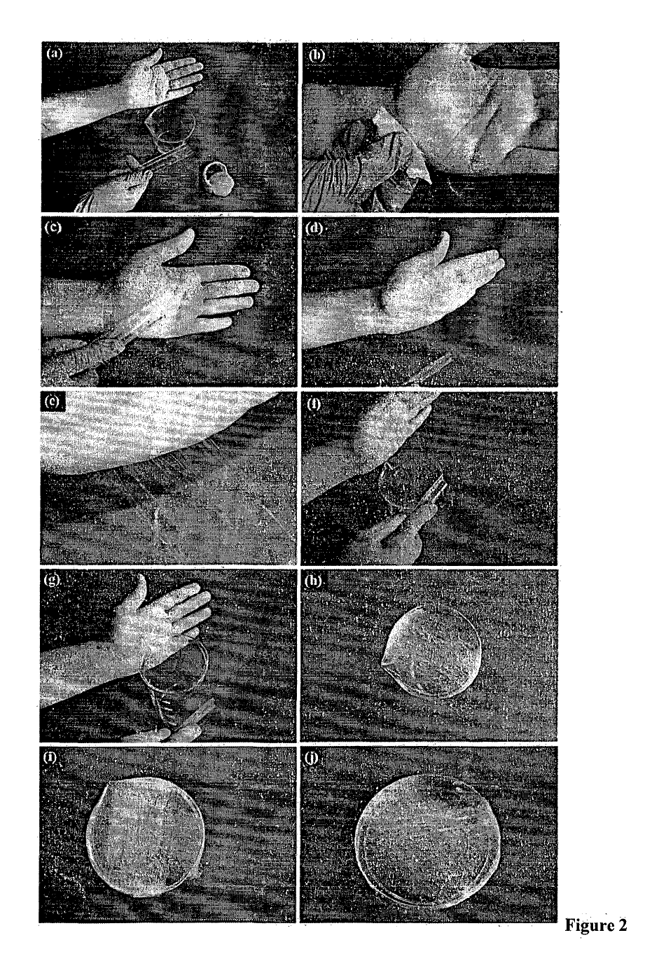

FIG. 2 illustrates the step wise procedure of fabrication of submicron fibers directly on the substrate or product to be deposited. In another embodiment, the sample from the peel can be directly squeezed on palm to initiate the process of fabrication. 2(a) shows the requirements for the process: squeeze the orange or take few drops of extract on palm 2(b) as per this embodiment or take few drops of the solvent collected as per FIG. 1; take scale or any other source of polystyrene waste and press it on the palm where solvent was sprayed 2(c); and pull the scale horizontally away from hand or palm 2(d). FIG. 2(e) shows the drawn fibers obtained from the present invention. Take fibers towards/on the substrate or object where it is to be deposited, here it is cylindrical beaker as shown in FIG. 2(f). The fibers are placed carefully on the beaker as in 2(g) to obtain horizontal alignment of the polystyrene fibers as shown in 2(h). The above steps are repeated till solvent gets dried or till the desired thickness or geometry of the fiber is obtained. Similarly different geometries of the fibers can be obtained as shown in FIGS. 2(i) and 2(j). As mentioned, fibers have an advantage of being aligned. Geometry of the fibers prepared can be controlled since fibers are almost in one direction and can be easily directed at a particular angle.

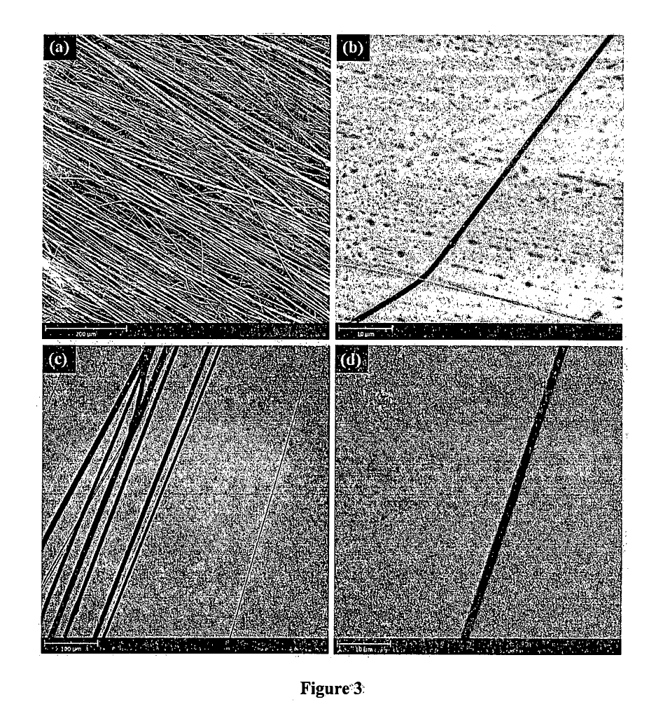

The above simple process of obtaining submicron fibers of polystyrene waste without any further processing or any other chemical solvent can be demonstrated from other citrus fruits like lemon, sweet lime, kinnows etc. Scanning Electron Microscope (SEM) is used to know the morphology of the polystyrene fibers obtained from any source of polystyrene waste using the different citrus fruits as the solvent. Polystyrene fibers fabricated by using orange peel extract have diameter in submicron range whose depiction is shown in FIGS. 3(a) and 3(b). The fibers obtained by using lemon peel extract is in submicron scale and are also found to be aligned as examined through SEM as shown in FIGS. 3(c) and 3(d).

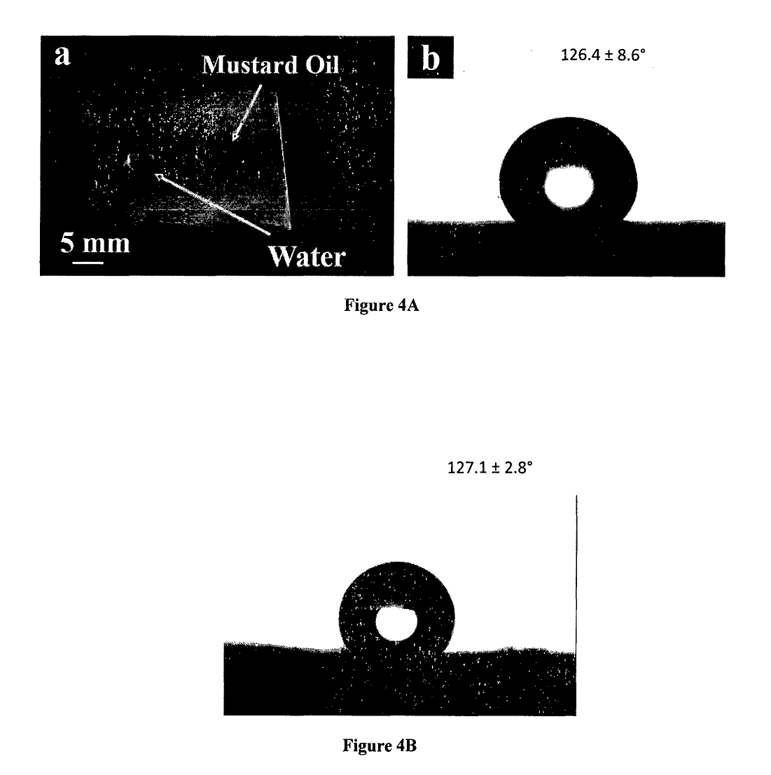

Contact angle goniometer was used to determine the wetting characteristics of these polystyrene fibers. Water contact angle for orange peel extract based fibers as shown in FIG. 4A (b) is found to be 126.4±8.6° while for lemon peel extract based fibers, water contact angle is found to be 127.1±2.8° as shown in FIG. 4b. Additionally, FIG. 4A (a) shows the oil droplet being completely absorbed on orange peel extract based recycled polystyrene fibers. This confirms the hydrophobic (water repellant) as well as oleophilic nature of these fibers obtained from the citrus fruit.

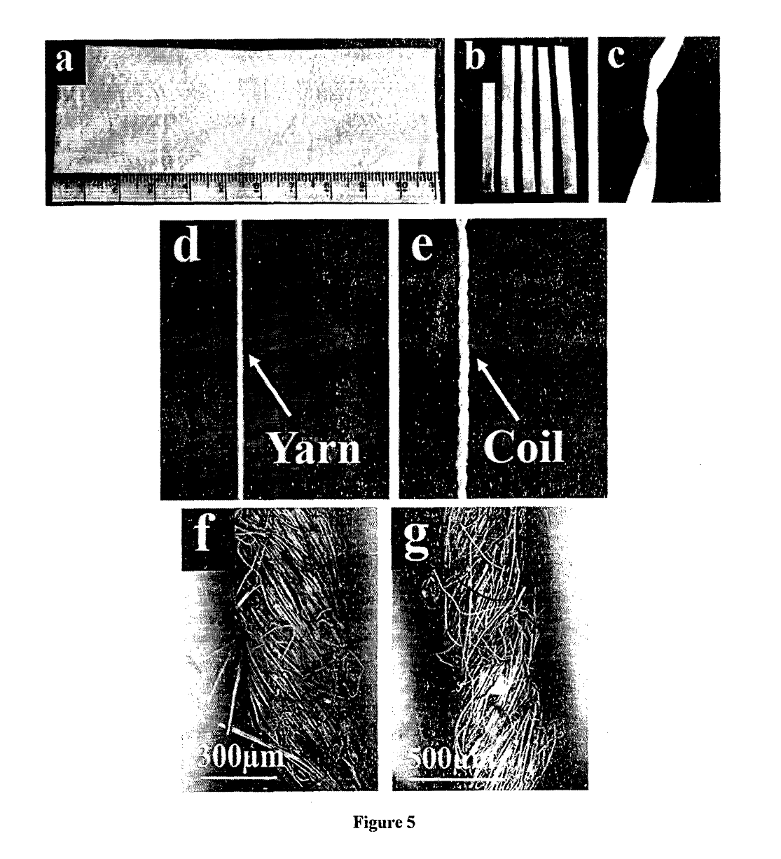

For potential use of the recycled polystyrene based fiber mat obtained using orange peel extract as solvent as textiles in the areas like healthcare, safety, these polystyrene fiber mats were twisted into yarn and coils as shown in FIG. 5. The polystyrene fiber mat (FIG. 5a) was first cut into long ribbons (FIG. 5b) and was twisted from one end as represented in FIG. 5c. After certain twists into ribbon, yarn was obtained (FIG. 5d). If the yarn was over twisted, it starts converting into coil (FIG. 5e). FIGS. 5f and 5g shows the SEM images of recycled polystyrene fibers derived yarn and coil respectively.

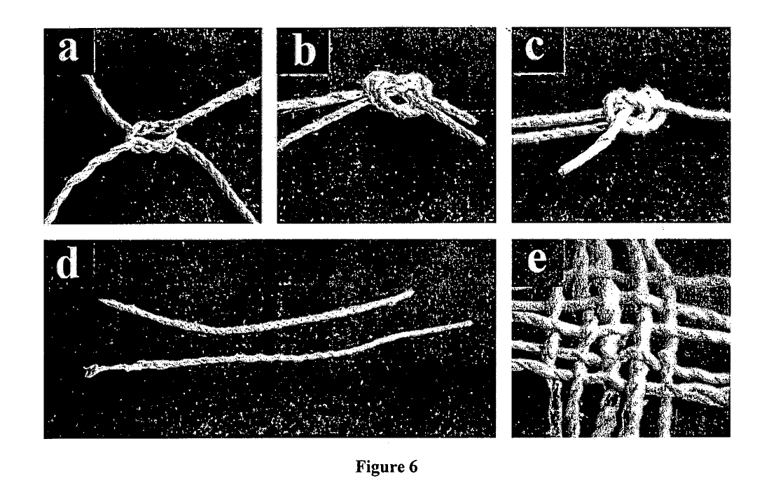

In processes such as winding, weaving, sewing, wrapping etc. two ends of the yarns or coils are connected by making knots. Some of the knots such as square, overhand and weaver's knot were tried using the coils produced as described above in FIG. 5. These different types of knotted structures are shown in FIG. 6. FIG. 6(a-c) shows the square, overhand and weaver's knot respectively. FIG. 6d shows the coils after opening the knot while FIG. 6 (e) shows the weaving of textile using different diameter coils.

Fibers obtained are hydrophobic as well as oleophilic with their diameter in sub-micron range. These fibers are obtained from recycled polystyrene waste using citrus peel extracts without any chemical addition or further treatment. Fibers are aligned and useful in making different geometries. Process of making film using this process is facile as well as fast and film obtained is free standing film.

Process set-up have minimum requirement and is inexpensive. This method is simple and flexible with respect to set-up and process. This process has the potential of being industrialized. Therefore, this method can be beneficial in dealing with the orange peel waste as well as recycling of polystyrene waste.

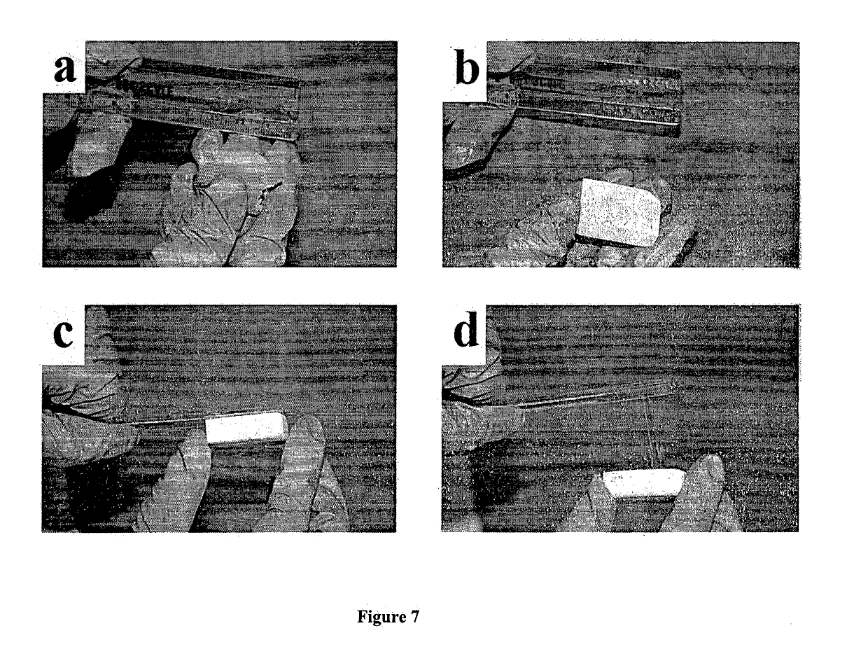

FIG. 7 illustrates the experimental set up wherein the hand on which the solvent sample is squeezed will be substituted by a smooth surfaced eraser with the source of polystyrene waste used as a plastic scale. The extract from the orange peel is squeezed on the scale taken as a source of polystyrene waste (7a); an eraser shall be taken as a flat surface to press the locally dissolved polystyrene scale in this experiment (7b); press the rubber on the scale where solvent was sprayed 7(c); and pull the rubber horizontally away from scale 7(d) to see the fibers drawn from the scale.

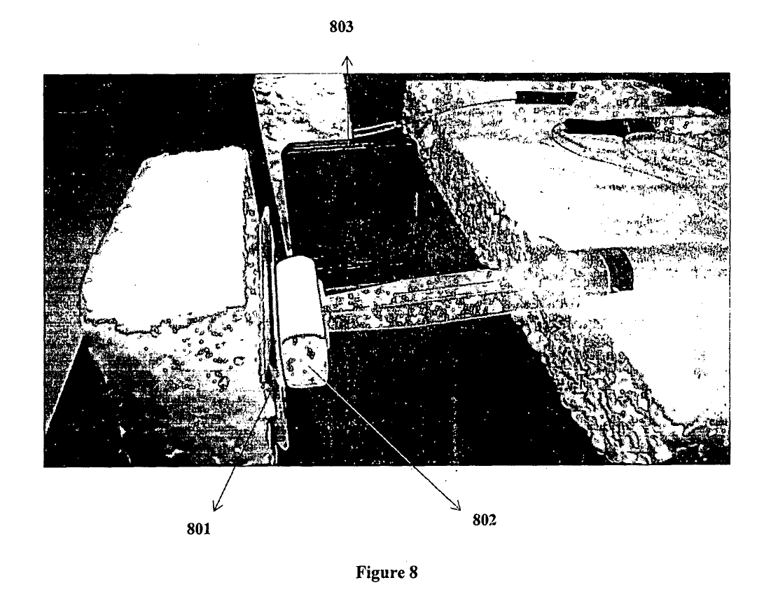

FIG. 8 illustrates the scaled up experimental set up wherein the whole process is mechanized in a pilot scale. The citrus peel extract is squeezed or pressed on the scale which is a source of polystyrene source which is stationary (801). The hand replaced here by a flat and soft surfaced eraser will be in a horizontal movement (802) so that it moves front and comes in contact with the scale which is stationary. The object which needs to be fabricated or the collector (803) in which the fibers are collected will also in a to and fro movement to collect the fiber obtained when the eraser comes in contact with the scale.

1. A simple and cost-effective method of mechanical fabrication of micron, sub-micron or nanometer dimension, aligned free-standing, hydrophobic and oleophilic polystyrene waste based fibers using extracts from citrus peel as solvent without any chemical substance comprising the steps of:
i. Pressing the citrus peel and extracting the solvent on a polystyrene waste surface;
ii. Pressing the solvent on the polystyrene waste surface with a flat and soft surface;
iii. Making a circular movement on the flat surface by the source of polystyrene waste;
iv. Pulling the source of polystyrene horizontally away from the flat surface; and
v. Depositing the obtained fibers on a collector; and
vi. Repeating the step i to iv till the solvent gets dried.

2. The process of claim 1 wherein the solvent from the peel of any citrus fruit is extracted separately by only squeezing the citrus peel and directly collecting the solvent.

3. The process of claim 1 wherein the citrus peel can be chosen from a group comprising orange, lemon, sweet lime, kinnow and other citrus fruits available.

4. The process of claim 1 wherein the fibers obtained are aligned in one direction.

5. The process of claim 1 wherein different geometries of fibers are formed in one direction.

6. The process of claim 1 wherein the fibers obtained are free standing film of desired thickness that can withstand without support of any substrate.

7. The process of claim 1 wherein the diameter/size of the fibers obtained ranges from 0.6. microns to 2 microns.

8. Polystyrene waste derived fibers obtained by the process as in claim 1 are used to obtain coils and yarn where it finds application in textile industry.

9. Polystyrene waste derived fibers obtained by the process as in claim 1 are hydrophobic and oleophilic where it finds application as sorbent material for cleaning of oil spills in ocean, rivers, and other water bodies.
